(19) United States
(12) Patent Application Publication
(10) Pub. No.: US 2013/0101784 A1
(43) Pub. Date: Apr. 25, 2013

(54) SECURITY GUARD STRAP COVER

(71) Applicants: Ronald D. Henry, Seattle, WA (US); Kurt K. Peterson, Lynnwood, WA (US)

(72) Inventors: Ronald D. Henry, Seattle, WA (US); Kurt K. Peterson, Lynnwood, WA (US)

(21) Appl. No.: 13/280,906

(22) Filed: Oct. 25, 2011

(51) Int. Cl. B32B 3/08; B32B 3/06; B23P 11/00

(52) U.S. Cl. 428/99; 29/428; 428/172; 428/136; 428/100

(57) ABSTRACT

Security guard strap covers that are selectively attachable to a conventional strap (e.g., a camera strap) and configured to prevent someone from cutting the strap when worn by a user. The security guard strap covers are embedded with a substantially cut-resistant material, such as a steel cable, which functions to protect straps from being cut or slashed with a knife or other cutting tool. The security guard strap cover protects a substantial portion of the length of a strap that is typically located on the back side of a user whereat the risk of cutting by a thief is the greatest.

### FIELD OF THE INVENTION

Embodiments of the present invention relate generally to protecting straps for carrying valuable objects, and more particularly, to security guard strap covers for protecting valuable objects from theft or damage.

### BACKGROUND

Conventional straps help users store and transport various objects when not in use. Such objects may include cameras, camera bags, video recording devices, laptop bags, purses, and the like. Typically, a user will position a strap over one of his shoulders such that the object rests comfortably by his side.

In some places, thieves have been known to approach an unsuspecting person from behind, cut a strap with a quick cut of a sharp knife, and steal the valuable object attached to the strap. To protect against this, users may wrap the strap multiple times around their wrist or they may keep the strap and/or valuable object clasped in their hands. Other users may simply decide not to carry the valuable object with them when they travel to places where the risk of theft is relatively high. Since it is desirable to carry objects such as cameras as one travels throughout the world, these current methods of mitigating the risk of theft are a substantial inconvenience.

### BRIEF DESCRIPTION OF THE DRAWINGS

FIG. 1A is a view of an implementation of a security guard strap cover, shown covering a strap being worn diagonally across the back of the torso of a user.

FIG. 1B is an enlarged view of a portion of the security guard strap cover shown in FIG. 1A.

FIG. 2A is a front view of the security guard strap cover shown in FIG. 1A disconnected from the strap and with a top flap and a bottom flap in an open position.

FIG. 2B is a back view of the security guard strap cover shown in FIG. 1A disconnected from the strap and with the top flap and the bottom flap in an open position.

FIG. 3A is front view of the security guard strap cover shown in FIG. 1A disconnected from the strap and with the top flap and the bottom flap in a closed position.

FIG. 3B is a back view of the security guard strap cover shown in FIG. 1A disconnected from the strap and with the top flap and the bottom flap in the closed position.

FIG. 4A illustrates the security guard strap cover during a first step of the installation process, wherein the top flap and the bottom flap are in the open position and the strap is inserted into a slotted loop of the strap cover.

FIG. 4B illustrates the security guard strap cover during a second step of the installation process, wherein the strap is positioned adjacent a center body of the strap cover.

FIG. 4C illustrates the security guard strap cover during a third step of the installation process, wherein the bottom flap is in the closed position over the strap and the top flap is in the open position.

FIG. 4D illustrates the security guard strap cover during a fourth and final step of the installation process, wherein the top flap and the bottom flap are secured in the closed position over the strap.

### DETAILED DESCRIPTION

Embodiments of the present invention are directed to security guard strap covers that are selectively attachable to the back of a conventional strap and configured to prevent someone from cutting the strap from behind when worn by a user. As discussed below, the strap covers are embedded with a substantially cut-resistant material, such as a steel cable, which functions to protect straps from being cut or slashed with a knife or other cutting tool. In this regard, users may continue to use their conventional straps to carry their objects while being protected from theft.

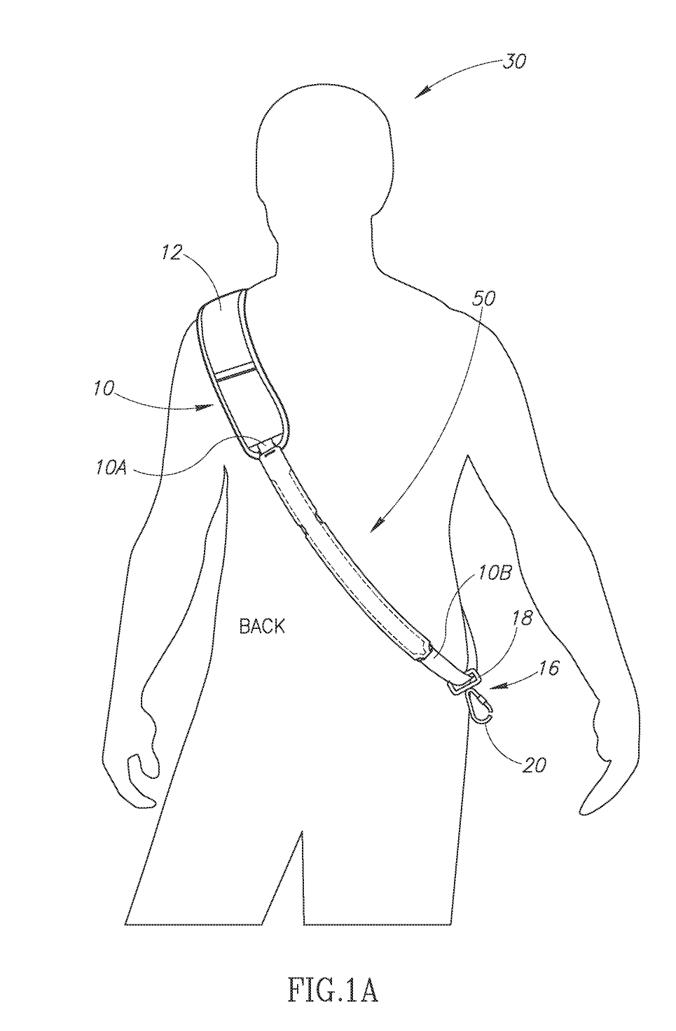

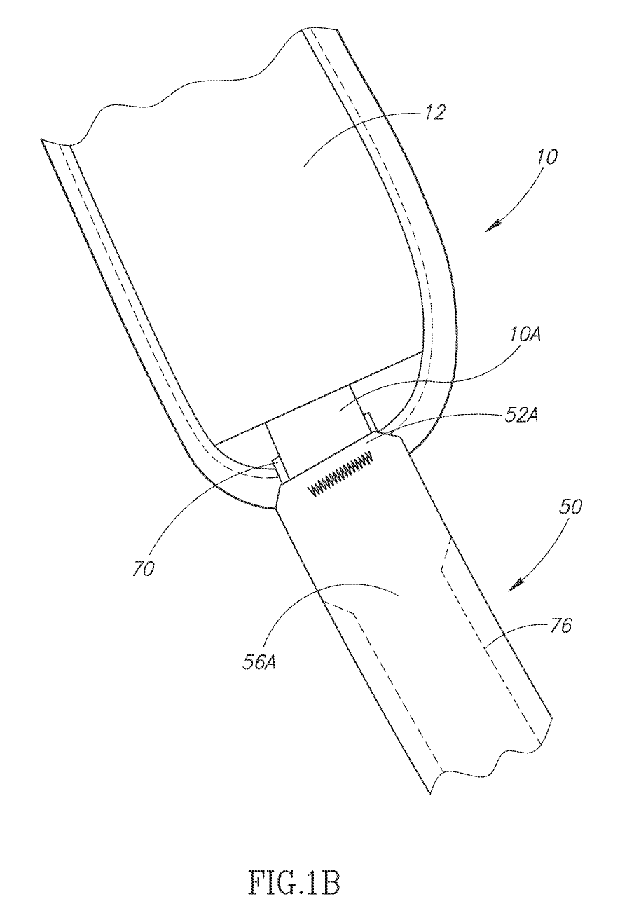

FIGS. 1A and 1B illustrate an embodiment of a security guard strap cover (or “strap cover”) 50 removably attached to a conventional strap 10 between an upper end portion 10A and a lower end portion 10B and below a shoulder pad 12 of the strap. The strap 10 may be formed into a loop and sized to fit over the torso of a user 30 and may be worn diagonally, like a bandolier, or worn vertically draped over a shoulder. As shown, the strap cover 50 is positioned on a portion or length of the strap 10 that is located on the back side of the user 30 such that a substantial portion of the strap between the shoulder pad 12 and the lower end portion 10B of the strap is covered by the strap cover. This feature minimizes the length of the strap 10 on the user's back side that is not covered by the strap cover 50. In some implementations, the strap 10 has a flat sectional profile as shown and, in other implementations, the strap may have other sectional profiles including oblong and round profiles, or the like. In this regard, the strap cover 50 may be sized and shaped to cover various types of straps as desired.

As can be appreciated, a camera or other valuable object may be selectively coupled to the strap 10 via a coupler 16. The object can then rest near the lower end portion 10B of the strap 10 when not in use. In the illustrated embodiment, the coupler 16 includes a loop 18 for slidably engaging the strap 10 and has a connector 20 attached to the loop 18. In this example, the connector 20 is of the hook type or carabineer type, and has a gate-style mechanism to permit connecting and disconnecting of the connector to an object such as a camera (not shown), which facilitates separation of the object from the user without removing the strap 10 from the user. It will be appreciated that other types of couplers may be provided. Further, some straps may be permanently attached to the valuable object. Such straps may include straps for products such as camera bags, laptop bags, purses, and the like.

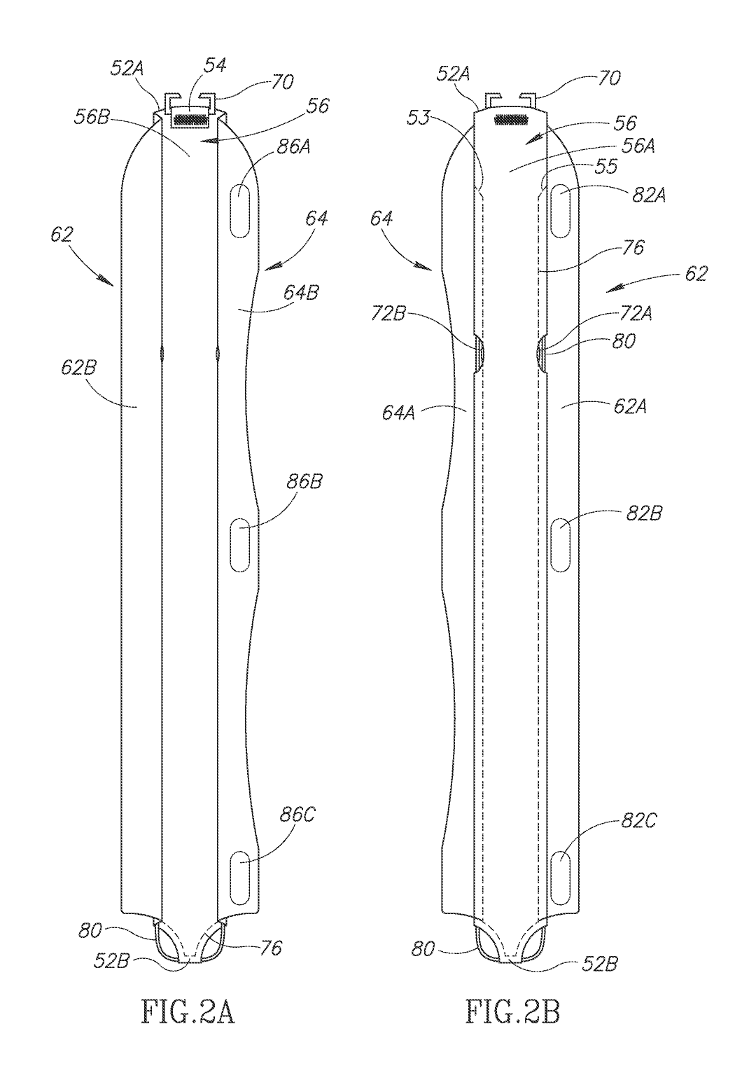

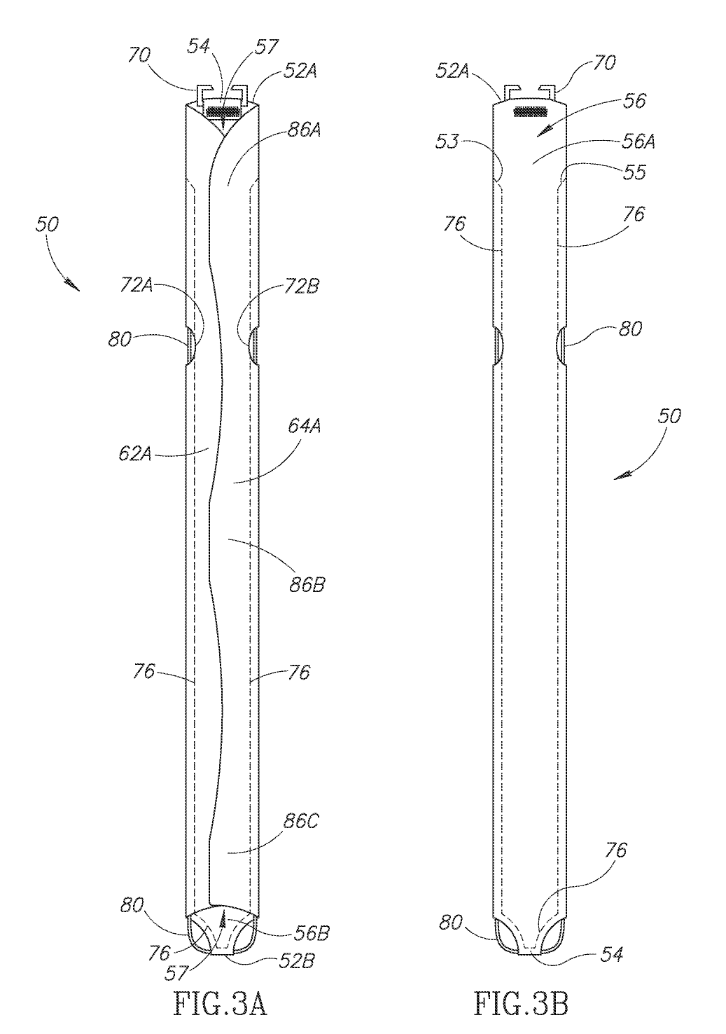

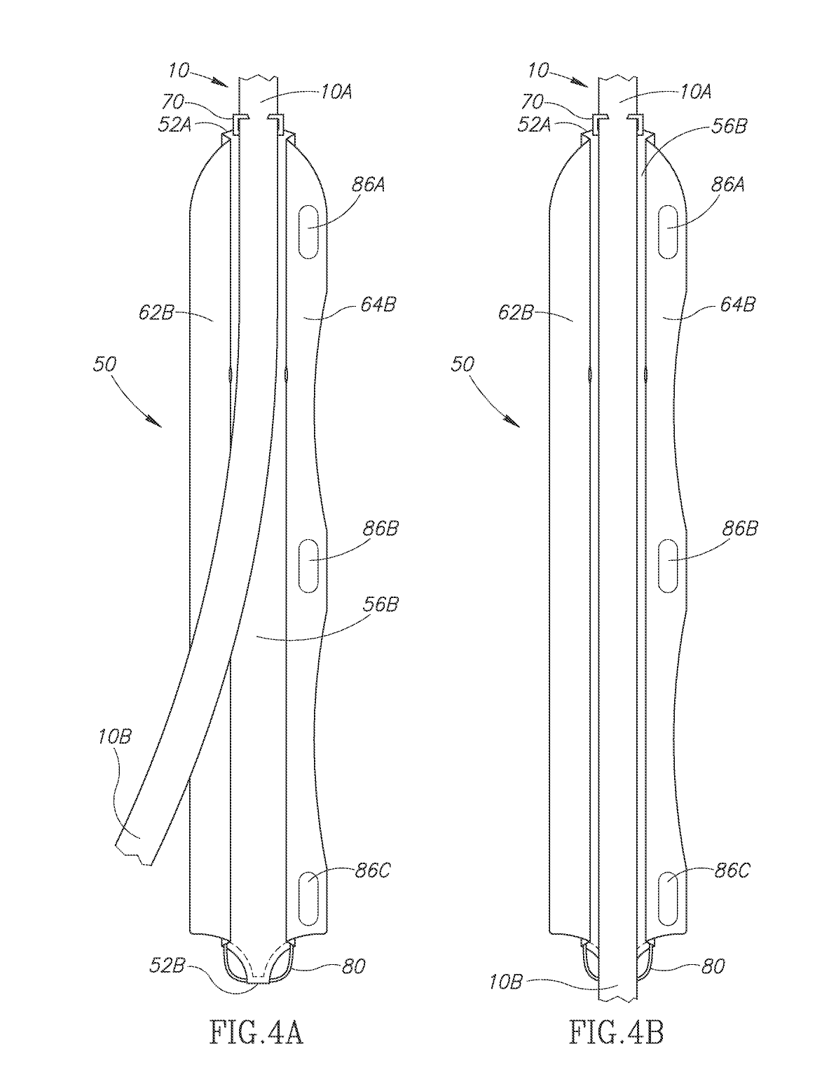

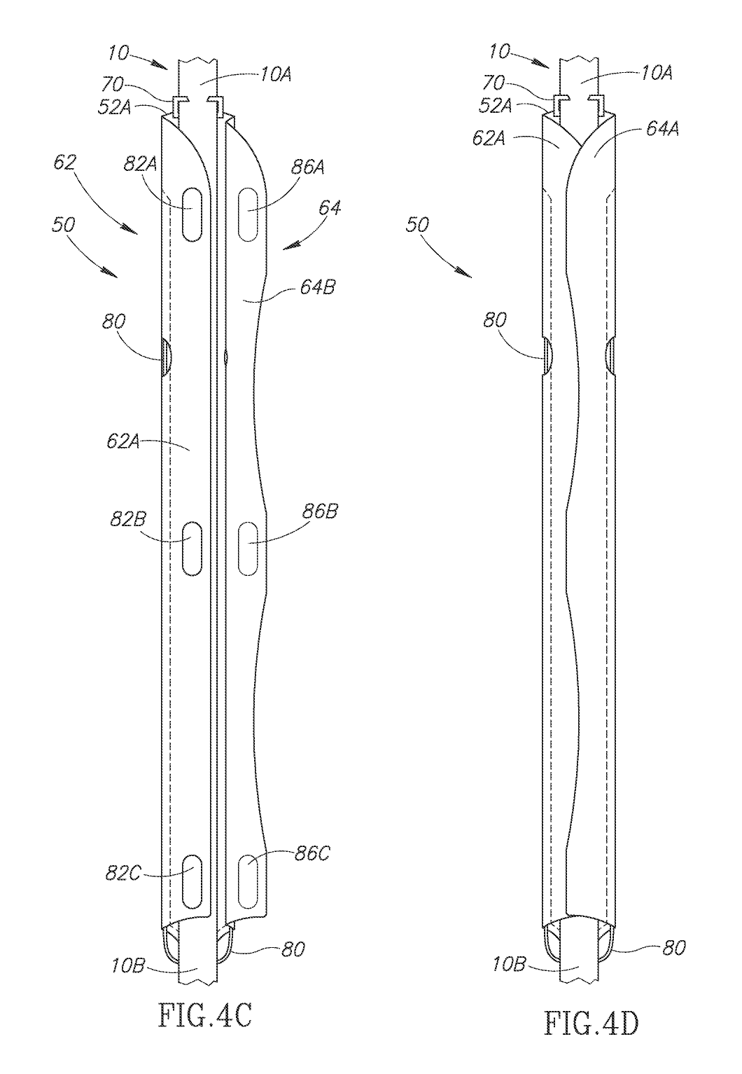

FIGS. 2A and 2B illustrate front and back views, respectively, of the security guard strap cover 50 when in an open position without the strap 10 being shown, and FIGS. 3A and 3B illustrate front and back views, respectively, of the security guard strap cover in a closed position without the strap 10 being shown. The strap cover 50 includes a body comprising an elongated center body 56, a bottom flap 62, and a top flap 64. The center body 56 has an upper end portion 52A and a lower end portion 52B. The width of the center body 56 may be configured to be slightly larger than the straps intended to be used with the strap cover 50 so that the straps may be sandwiched between the center body 56 on one side and the bottom and top flaps 62 and 64 on the other side. In the illustrated embodiment, the center body 56 has a width that is slightly larger than the width of the strap 10 (see FIG. 4B). The bottom flap 62 and the top flap 64 extend substantially along the full length of the center body 56 between the upper end portion 52A and the lower end portion 52B. When the flaps 62 and 64 are in the closed position as shown in FIG. 3A, they overlap and an elongated strap channel or cavity 57 is formed between them and the center body 56 that extends in the longitudinal direction and is sized to receive a corresponding length of the strap 10. Throughout the drawings, the “outside” surfaces of the center body 56, bottom flap 62 and top flap 64 are designated with the letter “A,” and the “inside” surfaces are designated with the letter “B.” For example, in FIGS. 2A and 2B, the inside surface of the bottom flap 62 is designated as inside surface 62B and the outside surface is designated as outside surface 62A. When the strap 10 is positioned in the elongated strap cavity 57, the one face of the strap is facing the inside surface 56B of the center body 56 and the other face of the strap is facing the inside surface 62B of the bottom flap 62, with the outside surface 62A of the bottom flap 62 facing the inside surface 64B of the top flap 64.

As shown in FIG. 2A, the inside surface 64B of the top flap 64 includes three spaced-apart hook tape pieces 86A, 86B, and 86C. As shown in FIG. 2B, the outside surface 62A of the bottom flap 62 includes three corresponding spaced-apart loop tape pieces 82A, 82B, 82C positioned to releasably engage the hook tape pieces 86A, 86B, and 86C, respectively, when the flaps 62 and 64 are folded from the open position into the closed position. The hook tape pieces 86A, 86B, and 86C and the loop tape pieces 82A, 82B, and 82C may be coupled to the top flap 64 and the bottom flap 62, respectively, by any suitable manner (e.g., sewn together). It will be appreciated that, in addition to such Velcro® type fasteners, other types of fasteners may be used to selectively releasably attach the top flap 64 and the bottom flap 62 together, including snaps, buttons, magnets, and the like.

The upper end portion 52A of the center body 56 includes a c-shaped slotted loop 70 that is secured to the center body by small flap portion 54 stitched to the center body (see FIG. 2A). As shown in FIG. 4A and discussed below, the slotted loop 70 is configured to receive and engage the strap 10 to help prevent the strap cover 50 from sliding along or otherwise moving relative to the strap during use.

In the embodiment illustrated, the center body 56 and the flaps 62 and 64 are integrally formed from a single piece of material, although this is not a requirement. Further, any suitable material may be used to form the center body 56 and the flaps 62 and 64. Examples of suitable materials include, but are not limited to, vinyl-coated polypropylene and chlorosulfonated polyethylene (CSPE) synthetic rubber (CSM) (e.g., HYPALON®).

As may best be viewed in FIG. 2B, the strap cover 50 also includes a cable 80 disposed around the perimeter or edge of the center body 56 inside channels formed by stitching 76 that extends downward along and spaced inward from the perimeter of the center body from a position 53 on its left edge, around the lower end portion 52B, and upward to a position 55 on its right edge. The stitching 76 runs off the edge of the center body 56 at the positions 53 and 55 to entrap the cable 80 within the channels formed in the strap cover 50. Since the blade of a knife or other cutting tool is most likely to first contact the strap cover 50 at its perimeter, this location for the cable 80 is well suited to protect the strap 10 from being cut during an attempted robbery.

As shown in FIGS. 3A and 3B, the strap cover 50 optionally includes cut out portions 72A and 72B configured to expose a portion of the cable 80 to allow a user to view the cable. In the illustrated embodiment, the cable 80 is also exposed near the lower end portion 52B of the center body 56. In some embodiments, the cable 80 may be formed from steel, and may have a diameter of approximately 1.5 mm. In some embodiments, the cable 80 may be coated with a suitable material, such as clear vinyl (e.g., polyvinyl chloride). It should be appreciated that other types of materials and sizes may be used to form a substantially cut-resistant cable, including various plastic materials, metal materials, composite materials, synthetic materials (e.g., KEVLAR®, etc.), any combinations thereof, and the like. Further, the strap cover 50 may include cut-resistant material embedded in other ways to achieve similar functionality.

FIGS. 4A-4D illustrate a step-by-step process for selectively attaching or installing the security guard strap cover 50 onto the strap 10 between its upper end portion 10A and the lower end portion 10B. Initially, the strap cover 50 is in the open position. As shown in FIGS. 4A and 4B, a user may first pass the upper end portion 10A of the strap 10 through the slot in the slotted loop 70 and position the strap 10 adjacent the inside surface 56B of the center body 56 along its full length as shown in FIG. 4B.

Next, as shown in FIG. 4C, the user may fold the bottom flap 62 over the strap 10 such that the inside surface 62B of the bottom flap is adjacent the strap and the outside surface 62A is facing outward. In this position, the loop tape pieces 82A, 82B, and 82C are also facing outward. As shown in FIG. 4D, the user may then fold the upper flap 64 over the outside surface 62A of the bottom flap 62 so that the hook tape pieces 86A, 86B, and 86C on the inside surface 64B engage the loop tape pieces 82A, 82B, and 82C, respectively. Once the strap cover 50 is fully installed, the strap 10 may be worn normally by the user as shown in FIG. 1A.

When the strap cover 50 is installed over the strap 10 the slotted loop 70 and the flaps 62 and 64 apply sufficient friction forces to the strap to prevent the strap cover and strap from sliding relative to each other. Thus, the strap cover 50 remains in the position on the strap 10 desired by the user.

Embodiments of the present invention provide numerous advantages. For example, the embedded cut-resistant material in the strap cover described herein significantly reduces the likelihood that a user's valuable objects will be stolen by a thief cutting their strap. Further, since the strap cover is configured to be selectively attached to conventional shoulder straps, users may continue to use the straps they have previously purchased. Another advantage provided by the embodiments of the present invention is that a user may utilize a single strap cover at different times to protect several of their straps for various objects (e.g., camera straps, laptop bag straps, and the like). Those skilled in the art will readily appreciate these and other advantages provided by the present disclosure.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A strap cover for protecting a length of a strap, the strap cover comprising:
an elongate body having a length corresponding to the length of the strap, the body having a strap channel extending longitudinally therethrough for selectively receiving the length of the strap; and
a cut-resistant material coupled to the body and extending longitudinally along at least a portion of the length of the body.

2. The strap cover of claim 1 wherein the cut-resistant material comprises a steel cable.

3. The strap cover of claim 1, further comprising a slotted loop fixedly coupled to an upper end portion of the body and configured to receive the strap therethrough.

4. The strap cover of claim 1 wherein the body is formed from one of vinyl-coated polypropylene and chlorosulfonated polyethylene (CSPE) synthetic rubber (CSM).

5. The strap cover of claim 1 wherein the body comprises an elongate center body disposed between a top flap and a bottom flap, the top flap and the bottom flap being selectively attachable to each other to form the strap channel between the center body on one side and the top flap and the bottom flap on another side.

6. The strap cover of claim 5 wherein the bottom flap has an outside surface that comprises one of a hook fastener and a loop fastener and the top flap has an inside surface that comprises the other of the hook fastener and the loop fastener, the hook fastener and loop fastener being aligned such that they are selectively engageable with each other when the inside surface of the top flap is positioned adjacent the outside surface of the bottom flap.

7. The strap cover of claim 5 wherein each of the bottom flap and the top flap extend longitudinally between a first end portion of the body and a second end portion of the body.

8. The strap cover of claim 5, further comprising:
a channel formed along the length of the center body sized and configured to receive the cut-resistant material.

9. The strap cover of claim 8 wherein the cut-resistant material comprises a metal cable and the channel extends longitudinally along at least one edge of the center body.

10. The strap cover of claim 9 wherein the body has portions where the cable is at least partially visible.

11. The strap cover of claim 9 wherein the cable is coated with a clear material.

12. The strap cover of claim 5, further comprising a pair of spaced-apart channels, each formed along the length of the center body sized and configured to receive a portion of the cut-resistant material.

13. The strap cover of claim 12 wherein the channels each extend along an opposing edge of the center body.

14. The strap cover of claim 5 wherein the bottom flap comprises one of a plurality of spaced-apart hook fasteners and a plurality of spaced-apart loop fasteners and the top flap comprises the other of a plurality of spaced-apart hook fasteners and a plurality of spaced-apart loop fasteners.

15. The strap cover of claim 5, further comprising a slotted loop fixedly coupled to an upper end portion of the center body and configured to receive the strap therethrough.

16. The strap cover of claim 5 wherein the center body, the bottom flap, and the top flap are integrally formed from a single piece of material.

17. The strap cover of claim 16 wherein the center body, the bottom flap, and the top flap are formed from one of vinyl-coated polypropylene and chlorosulfonated polyethylene (CSPE) synthetic rubber (CSM).

18. A strap cover for protecting a length of a strap, the strap cover comprising:
an elongate body having a length corresponding to the length of the strap, the body comprising a substantially rectangular-shaped center body having first and second longitudinal edges, a first flap coupled to the first longitudinal edge and a second flap coupled to the second longitudinal edge, the first flap and the second flap being selectively attachable to each other such that, when attached, a strap channel for receiving the length of the strap is formed between the center body on one side and the first flap and the second flap on another side; and
a cut-resistant cable coupled to the center body and extending longitudinally along at least a portion of each of the first and second longitudinal edges.

19. The strap cover of claim 18, further comprising a slotted loop fixedly coupled to an upper end portion of the center body and configured to receive the strap therethrough.

20. A method for protecting a length of a strap, the method comprising:
providing a strap cover comprising an elongate body having a length corresponding to the length of the strap, the body having a strap channel extending longitudinally therethrough for selectively receiving the length of the strap, and a cut-resistant material coupled to the body and extending longitudinally along at least a portion of the length of the body; and
positioning the length of the strap within the strap channel.

21. The method of claim 20, wherein the body comprises an elongate center body disposed between a top flap and a bottom flap, and the positioning comprises:
positioning the length of the strap adjacent an inside surface of the center body;
folding the bottom flap over the strap so that an inside surface of the bottom flap is adjacent the strap;
folding the top flap over the bottom flap so that an inside surface of the top flap is adjacent an outside surface of the bottom flap; and
releasably attaching the top flap and the bottom flap to each other.

22. The method of claim 21, wherein the strap cover further comprises a slotted loop fixedly coupled to an upper end portion of the center body, the method further comprising passing the strap through the slotted loop.

23. A strap cover for protecting a shoulder strap having a front portion positionable at the front side of a person and a rear portion positionable at the rear side of the person, the strap cover comprising:
a substantially rectangular-shaped center body having a length corresponding to a predetermined length of the rear portion of the shoulder strap and a width that is at least as large as the width of the rear portion of the shoulder strap, the center body further having an inside surface positionable adjacent the predetermined length of the rear portion of the shoulder strap, an opposite outside surface, and first and second longitudinal edge portions;
a first flap movably coupled to the first longitudinal edge portion of the center body;
a second flap movably coupled to the second longitudinal edge portion of the center body, the first flap and the second flap being selectively attachable to each other to selectively fasten the strap cover to the rear portion of the shoulder strap with the predetermined length of the rear portion of the shoulder strap between the center body on one side and the first flap and the second flap on another side; and
a cut-resistant material coupled to the center body and extending longitudinally along at least a portion of each of the first and second longitudinal edge portions.

24. The strap cover of claim 23, further comprising a pair of spaced-apart channels each formed along the length of the center body sized and configured to receive a portion of the cut-resistant material.

25. The strap cover of claim 24 wherein the channels each extend along an opposing edge portion of the center body.

26. The strap cover of claim 23 wherein the cut-resistant material comprises a steel cable.

27. The strap cover of claim 23 wherein the first and second flaps are movable to position the first flap against the rear portion of the shoulder strap and to position the second flap overlaying the first flap with the inside surface of the second flap adjacent the outside surface of the first flap, the first flap having an outside surface that comprises one of a hook fastener and a loop fastener and the second flap having an inside surface that comprises the other of the hook fastener and the loop fastener, the hook fastener and loop fastener being aligned such that they are selectively engageable with each other when the inside surface of the second flap is positioned adjacent the outside surface of the first flap.

28. The strap cover of claim 27 wherein the inside surface of the center body is positionable adjacent a first face of the predetermined length of the rear portion of the shoulder strap and the inside surface of the first flap is positionable adjacent an opposite second face of the predetermined length of the rear portion of the shoulder strap.

29. The strap cover of claim 23, further comprising a slotted loop fixedly coupled to an upper end portion of the center body and configured to receive the rear portion of the shoulder strap therethrough.

30. The strap cover of claim 23 wherein the center body, the first flap, and the second flap are integrally formed from a single piece of material.
